(19) United States
(12) Patent Application Publication
(10) Pub. No.: US 2004/0069544 A1
(43) Pub. Date: Apr. 15, 2004

(54) Combined truck and delivery box auger apparatus

(76) Inventor: Daniel R. Brauer, Beloit, WI (US)

Correspondence Address: DAVID J. ARCHER, 9790 FOREST PRESERVE RD., DURAND, IL, 61024, US

(21) Appl. No.: 10/270,019

(22) Filed: Oct. 11, 2002

(51) Int. Cl. B60K 25/00

(52) U.S. Cl. 180/53.4

(57) ABSTRACT

A combined truck and delivery box auger apparatus is disclosed for transporting, discharging and optionally mixing feed. The apparatus includes a chassis and an engine secured to the chassis. A transmission is drivingly coupled to the engine. A gearbox is secured to the chassis, the gearbox having a first and a second input and an output. The output of the gearbox is selectively driven by the first and second input, the first input being drivingly connected to the transmission. The second input is drivingly connected to a hydraulic motor which is driven by the engine. The arrangement is such that in a first mode of operation, the truck is driven by the transmission and in a second mode of operation, the truck is driven by the hydraulic motor, the second mode of operation enabling a slow ground speed for the discharge of the feed.

### BACKGROUND OF THE INVENTION

1. Field of the Invention

The present invention relates to a combined truck and delivery box auger apparatus. More specifically, the present invention relates to a combined truck and delivery box auger apparatus for transporting, discharging and optionally mixing feed.

2. Background Information

Many delivery box augers for delivering animal feed and the like are mounted on the back of a truck so that the feed can be optionally mixed and then driven to a feeding location so that the feed can be discharged for feeding in a livestock feeding operation. However, the mixing and discharging operations require a relatively high rate of engine rotation and power for operating the auger within the mixer and such power is supplied from a power take off from the truck transmission. Such high rate of engine rotation and power for the mixer auger presents a problem in that it is difficult to regulate the output of the transmission and to at the same time provide a relatively slow ground speed for driving the wheels of the truck when discharging the feed. Consequently, prior art arrangements have necessitated multiple passes by the operator because it has been impossible to drive very slowly past each feed station for discharging the mixed feed while at the same time maintaining a high rate of rotation of the auger to ensure adequate discharge of the feed. Thus, additional passes are required so that enough feed is provided at the feed station.

The present invention overcomes the aforementioned problem of the prior art arrangements by providing an auxiliary gearbox disposed between the transmission and the driven wheels of the truck. The arrangement is such that the driven wheels can be driven by the transmission during road usage and transportation of the feed. However, during a feed discharging operation, the gearbox is selectively driven via a hydraulic pump and motor connected to a second input of the gearbox. Such an arrangement according to the present invention permits the operator to move extremely slowly past the feed stations during a feed discharging operation while maintaining the high rotational speed of the engine and power to operate the auger required for assuring adequate discharge of the feed.

Therefore, it is a primary feature of the present invention to provide a combined truck and delivery box auger apparatus that overcomes the problems associated with the prior art arrangements.

Another feature of the present invention is the provision of a combined truck and delivery box auger apparatus that decreases the time required to complete a feed discharging operation because multiple passes are not required.

Other features and advantages of the present invention will be readily apparent to those skilled in the art by a consideration of the detailed description of a preferred embodiment of the present invention contained herein.

### SUMMARY OF THE INVENTION

The present invention relates to a combined truck and delivery box auger apparatus for transporting, discharging and optionally mixing feed. The apparatus includes a chassis and an engine secured to the chassis. A transmission is drivingly coupled to the engine and a power take off is connected to the transmission. A driveline is disposed between the power take off and the delivery box auger for driving the delivery box auger and for optionally mixing the feed. Also, a gearbox is secured to the chassis, the gearbox having a first and a second input and an output. The output of the gearbox is connected to the truck drive wheels and is selectively driven by the first and second input, the first input being drivingly connected to the transmission. The second input is drivingly connected to a hydraulic motor. A hydraulic pump is drivingly connected to the hydraulic motor, the hydraulic motor being driven by the hydraulic pump which in turn is driven by the engine. The arrangement is such that in a first mode of operation, the truck drive wheels are driven by the transmission and in a second mode of operation, the truck drive wheels are driven by the hydraulic motor, the second mode of operation providing a very slow ground speed for discharging the feed.

In a more specific embodiment of the present invention, the driven wheels are driven by the output of the gearbox.

Furthermore, the chassis supports the delivery box auger and the engine is disposed remote from the driven wheels.

Moreover, the transmission is a stick shift type transmission. However, in another embodiment of the present invention, the transmission is an automatic transmission.

In both embodiments of the present invention, the power take off is selectively driven by the transmission so that when the power take off is being driven by the transmission, the auger within the delivery box is rotated for mixing and/or discharging the feed.

Also, when the power take off is selectively disconnected from the transmission, the auger within the delivery box is not rotated.

Preferably, the driveline is a mechanical driveline for rotating the delivery box auger. However, in an alternative arrangement, the driveline for rotating the auger of the delivery box is a hydraulic drive with a pump at the PTO and a motor at the delivery box auger.

Additionally, the gearbox is a dual or double input gearbox. More specifically, the first input is connected to the transmission so that when the first input is selected, the apparatus is driven at a first speed and when the second input is connected to the hydraulic motor, the second input is selected, and the apparatus is driven at a second speed.

More particularly, the second speed can be slower than the first speed.

The apparatus further includes a planetary gearbox which is disposed between the hydraulic motor and the second input. More specifically, the planetary gearbox has a 6:1 ratio.

Also, the hydraulic motor has a displacement within a range 3.30-3.40 cubic inches and the hydraulic pump has a displacement within a range 5.90-6.10 cubic inches.

The apparatus also includes a shift control for controlling the output of the gearbox such that the control permits selective drive of the output by the first and the second input.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view partially in section of a combined truck and delivery box auger apparatus according to the present invention for transporting, discharging and optionally mixing feed; and

FIG. 2 is a similar view to that shown in FIG. 1 but shows an alternative embodiment of the present invention in which the transmission is an automatic transmission.

Similar reference characters refer to similar parts throughout the various views and embodiments of the drawings.

### DETAILED DESCRIPTION OF THE DRAWINGS

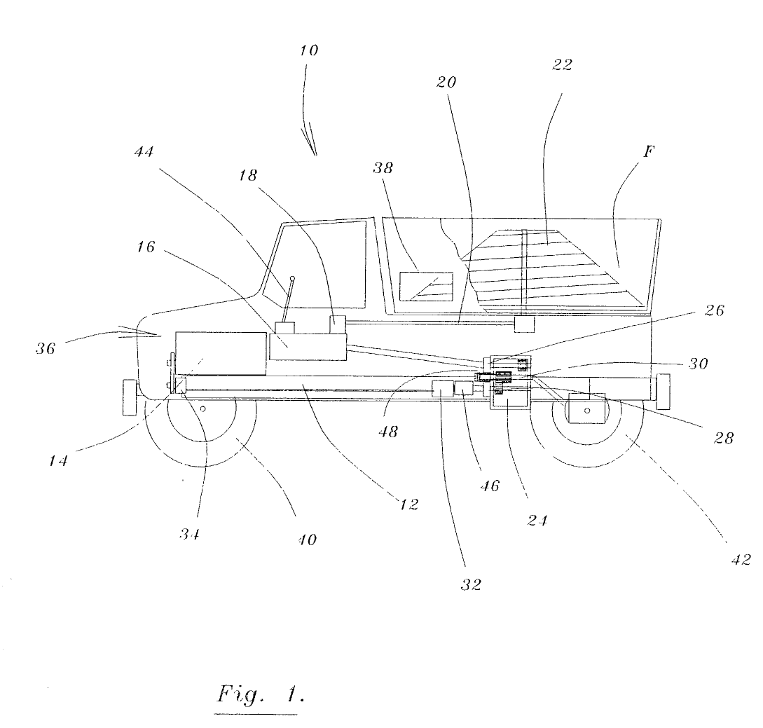

FIG. 1 is a side elevational view partially in section of a combined truck and delivery box auger apparatus generally designated 10 according to the present invention for transporting, discharging and optionally mixing feed F. As shown in FIG. 1, the apparatus 10 includes a chassis 12 and an engine 14 secured to the chassis 12. A transmission 16 is drivingly coupled to the engine 14 and a power take off 18 is connected to the transmission 16. A driveline 20 is disposed between the power take off 18 and a delivery box auger 22 for driving the delivery box auger 22 for mixing the feed F. Also, a gearbox 24 is secured to the chassis 12, the gearbox 24 having a first and a second input 26 and 28 respectively and an output 30. The output 30 of the gearbox 24 is selectively driven by the first and second input 26 and 28 respectively, the first input 26 being drivingly connected to the transmission 16. The second input 28 is drivingly connected to a hydraulic motor 32. A hydraulic pump 34 is drivingly connected to the hydraulic motor 32, the hydraulic motor 32 being driven by the hydraulic pump 34. The arrangement is such that in a first mode of operation, the truck generally designated 36, is driven by the transmission 16 and in a second mode of operation, the truck 36 is driven by the hydraulic motor 32, the second mode of operation enabling the delivering of the feed F via an outlet 38 defined by the delivery box auger 22.

In a more specific embodiment of the present invention, the apparatus 10 further includes a pair of wheels 40, the wheels 40 being connected to the chassis 12 and a pair of driven wheels 42 spaced from the wheels 40, the driven wheels 42 being driven by the output 30 of the gearbox 24.

Furthermore, the chassis 12 supports the delivery box auger 22 and the engine 14 is disposed remote from the driven wheels 42.

Moreover, the transmission 16 is a stick shift type transmission with a gear shift stick 44.

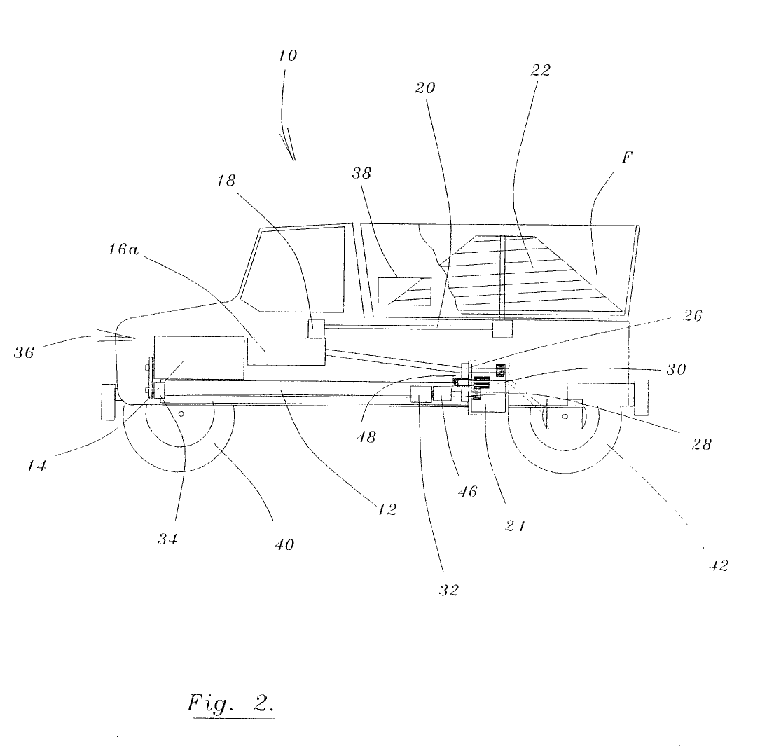

FIG. 2 is a similar view to that shown in FIG. 1 but shows an alternative embodiment of the present invention in which the transmission is an automatic transmission 16a.

In both embodiments of the present invention, the power take off 18 is selectively driven by the transmission 16 or 16a so that when the power take off 18 is being driven by the transmission 16 or 16a, the auger of the delivery box 22 is rotated for mixing the feed F.

Also, when the power take off 18 is selectively disconnected from the transmission 16 or 16a, the delivery box auger 22 is not operated.

Preferably, the driveline 20 is a mechanical driveline for operating the delivery box auger 22.

Additionally, the gearbox 24 is a dual input gearbox. More specifically, the first input 26 is connected to the transmission 16 so that when the first input 26 is selected, the apparatus 10 is driven at a first speed and when the second input 28 is connected to the hydraulic motor 32, the second input 28 is selected, and the apparatus 10 is driven at a second speed.

More particularly, the first speed is typically greater than the second speed.

The apparatus 10 further includes a planetary gearbox 46 which is disposed between the hydraulic motor 32 and the second input 28. More specifically, the planetary gearbox 46 has a 6:1 ratio.

Also, the hydraulic motor 32 has a displacement within a range 3.30-3.40 cubic inches and the hydraulic pump 34 has a displacement within a range 5.90-6.10 cubic inches.

The apparatus 10 also includes a shift control 48 for controlling the output 30 of the gearbox 24 such that the control 48 permits selective drive of the output 30 by the first input 26 and the second input 28. The shift control 48 is a mechanical shift, an electric shift, a hydraulic shift or an air shift control.

In operation of the apparatus according to the present invention, the operator is able to select the first input 26 by means of the shift control 48 so that the driven wheels can be driven by the transmission during road usage and transportation of the feed. However, during a feed discharge operation, the operator is able to select the second input by means of the shift control 48 so that the gearbox is now driven via the hydraulic pump 34 and hydraulic motor 32 connected to the second input 28 of the gearbox 24. Such an arrangement according to the present invention permits the operator to move extremely slowly past the feed bunks or feeding stations during the feed delivery operation while maintaining the high rotational speed of the auger required for assuring adequate discharge of feed.

The present invention provides a combined truck and delivery box auger which enables an operator to drive slowly past feeding stations for delivering feed thereto while maintaining adequate discharge of feed from the delivery box auger.

What is claimed is:

1. A combined truck and delivery box auger apparatus for transporting and discharging feed, said apparatus comprising:
a chassis;
an engine secured to said chassis;
a transmission drivingly coupled to said engine;
a gearbox secured to said chassis, said gearbox having a first and a second input and an output;
said output of said gearbox being selectively driven by said first and second input, said first input being drivingly connected to said transmission;
a hydraulic pump driven by said engine;
a hydraulic motor connected to and driven by said hydraulic pump; and
said second input being drivingly connected to said hydraulic motor, the arrangement being such that in a first mode of operation, the truck is driven by said transmission and in a second mode of operation, the truck is driven by said hydraulic motor, said second mode of operation enabling the truck to be driven at a slower speed for discharging of the feed.

2. A combined truck and delivery box auger apparatus as set forth in claim 1 including:
a power take off connected to said transmission;
a driveline disposed between said power take off and the delivery box auger for driving the delivery box auger for discharging the feed.

3. A combined truck and delivery box auger apparatus as set forth in claim 1 wherein
said apparatus further includes:
a pair of wheels, said wheels being connected to said chassis;
a pair of driven wheels spaced from said wheels, said driven wheels being driven by said output of said gearbox.

4. A combined truck and delivery box auger apparatus as set forth in claim 1 wherein
said chassis supports the delivery box auger.

5. A combined truck and delivery box auger apparatus as set forth in claim 3 wherein
said engine is disposed remote from said driven wheels.

6. A combined truck and delivery box auger apparatus as set forth in claim 1 wherein
said transmission is a stick shift type transmission.

7. A combined truck and delivery box auger apparatus as set forth in claim 1 wherein
said transmission is an automatic transmission.

8. A combined truck and delivery box auger apparatus as set forth in claim 2 wherein
said power take off is selectively driven by said transmission so that when said power take off is being driven by said transmission, the delivery box auger is rotated for discharging the feed.

9. A combined truck and delivery box auger apparatus as set forth in claim 2 wherein
when said power take off is selectively disconnected from said transmission, the delivery box auger is not rotated.

10. A combined truck and delivery box auger apparatus as set forth in claim 2 wherein
said driveline is a mechanical driveline for rotating said delivery box auger.

11. A combined truck and delivery box auger apparatus as set forth in claim 1 wherein
said gearbox is a dual input gearbox.

12. A combined truck and delivery box auger apparatus as set forth in claim 1 wherein
said first input is connected to said transmission so that when said first input is selected, the apparatus is driven at a first speed and wherein said second input is connected to said hydraulic motor so that when said second input is selected, the apparatus is driven at a second speed.

13. A combined truck and delivery box auger apparatus as set forth in claim 12 wherein
said first speed is typically greater than said second speed.

14. A combined truck and delivery box auger apparatus as set forth in claim 1 further including:
a planetary gearbox disposed between said hydraulic motor and said second input.

15. A combined truck and delivery box auger apparatus as set forth in claim 1 further including:
a shift control for controlling said output of said dual input gearbox such that said control permits selective drive of said output by said first and said second input.

16. A combined truck and delivery box auger apparatus as set forth in claim 1 further including:
a hydraulically driven motor drivingly connected to the delivery box auger for discharging feed from the delivery box auger.

17. A combined truck and delivery box auger apparatus as set forth in claim 16 further including:
a hydraulically operating pump driven by said transmission, said hydraulically operating pump driving said hydraulically driven motor.

18. A combined truck and delivery box auger apparatus for transporting, discharging and optionally mixing feed, said apparatus comprising:
a chassis;
an engine secured to said chassis;
a transmission drivingly coupled to said engine;
a gearbox secured to said chassis, said gearbox having a first and a second input and an output;
said output of said gearbox being selectively driven by said first and second input, said first input being drivingly connected to said transmission;
a hydraulic motor driven by said engine;
said first input being connected to said transmission so that when said first input is selected, the apparatus is driven at a first speed and wherein said second input is connected to said hydraulic motor so that when said second input is selected, the apparatus is driven at a slower second speed, the arrangement being such that in a first mode of operation, the truck is driven by said transmission and in a second mode of operation by said hydraulic motor, said second mode of operation enabling the discharge of the feed.

19. A combined truck and delivery box auger apparatus for transporting, discharging and optionally mixing feed, said apparatus comprising:
a chassis;
an engine secured to said chassis;
a transmission drivingly coupled to said engine;
a gearbox secured to said chassis, said gearbox having a first and a second input and an output;
said output of said gearbox being selectively driven by said first and second input, said first input being drivingly connected to said transmission;
a hydraulic motor driven by said engine;
said second input being drivingly connected to said hydraulic motor; and
said first input being connected to said transmission so that when said first input is selected, the apparatus is driven at a first speed and wherein said second input is connected to said hydraulic motor so that when said second input is selected, the apparatus is driven at a second speed, said first speed typically being greater than said second speed.
